(19) United States
(12) Patent Application Publication
(10) Pub. No.: US 2003/0002115 A1
(43) Pub. Date: Jan. 2, 2003

(54) Dynamic NPR boost

(75) Inventors: Marcel F.C. Schemmann, BN Echt (NL); Venkatesh G. Mutalik, Manlius, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/896,761

(22) Filed: Jul. 2, 2001

(51) Int. Cl. H04B 10/00; H04B 10/12

(52) U.S. Cl. 359/173; 359/154

(57) ABSTRACT

A method and apparatus for enhancing the effective dynamic range of an RF-to-optical-to-RF link. The transmission through an optical link of RF digital signals having magnitudes outside of the dynamic range of the link is performed by changing the amplitude of (e.g., attenuating) such signals prior to transmission, and restoring such signals to their original amplitude after transmission. Signal-to-Noise Ratio (e.g., Noise Power Ratio (NPR)) of such digital signals is thereby maintained above a predetermined minimum level. The method and apparatus have advantageous applications in bi-directional commercial CATV systems.

### BACKGROUND OF THE INVENTION

1. Technical Field

The present invention relates generally to transmission of RF digital signals through an optical link having a limited physical Dynamic Range, particularly a method and apparatus for enhancing the effective Dynamic Range of the link by sacrificing unneeded Signal to Noise Ratio, (e.g., Noise Power Ratio (NPR)) of such digital signals, the method and apparatus having advantageous applications in bi-directional commercial CATV systems.

2. Related Art

Commercial terrestrial Cable Television (CATV) systems now typically utilize optical links (e.g., fiber-optic cable, with RF transmitter-receiver pairs) to carry radio frequency (RF) digital signals over long distances.

FIG. 1A depicts a typical RF digital signal transmission system 100 of the related art. The related art system 100 includes an electro-optical transmitter (Tx, 120) that transmits the digital information signals (e.g., carried in as RF digital electrical signals RFin) through an Optical-Out port (121) into an optical LINK (130) as light signals to the Optical-In port (141) of an opto-electric Receiver (Rx,140) which outputs the received light signals as radio frequency (RF) digital signals (i.e., RF digital electrical signals RFout). The light signals passed through the optical link 130 (e.g., fiber optic cable) may be Wavelength-Division Multiplexed (WDM) signals. The RF digital electrical signals RFout output from the receiver 140 are generally reproductions of the original electrical signals RFin input to the transmitter 120 except for any gain/attenuation, noise and/or distortion introduced during passage through the system 100. A conductor 110 carries the radio frequency (RF) electronic signals RFin into the transmitter 120. The transmitter 120 may include a laser for transmitting the RF signals as light signals. A conductor 111 carries the radio frequency (RF) electronic signals RFout out of the receiver 140. The transmitter 120 and the 140 are generally electrically isolated, and separated by significant distances (e.g., several miles). A separate local power supply (not shown in the diagrams) supplies electrical power to each of the transmitter 120 and the receiver 140.

The extent to which a digital signal within RFin has been distorted or combined with noise is characterized by persons skilled in the art by known measurements (or calculations) referred to as Signal-To-Noise Ratio (SNR) and/or Noise Power Ratio (NPR). For purposes of discussion and illustration herein, NPR will be considered to be the same and/or analogous to SNR, except that distinct values of NPR (as measured between RFin and RFout) will be associated with “amplitudes” (e.g., RF power levels) of digital signals input to the system, rather than associated with particular continuous wave (CW) signals. Digital signals (RFin) transmitted out at amplitudes having an NPR equal to or greater than a predetermined minimum NPR (e.g., the current Industry Standard minimum NPR is 40) are considered to have acceptable fidelity, while signals (RFin) transmitted out at amplitudes having an NPR less than the predetermined minimum NPR (e.g., 40) are deemed unacceptably distorted and/or noisy.

In a typical digital signal transmission system of the related art, such as system 100 depicted in FIG. 1, the Noise Power Ratio (NPR) associated with digital signals (RFout) passing out of the system 100 may be characterized as a function of the amplitude (i.e., signal strength measured in dBmV) of the inputted signals (RFin). Digital signals RFin that have insufficient amplitude (i.e., having amplitude smaller than the smallest amplitude that will emerge from the system 100 with an NPR equal to or greater than the predetermined minimum NPR) will emerge too noisy or distorted (i.e., with a SNR that is too small and/or with a NPR less than 40). Digital signals RFin that have a large amplitude can be clipped (i.e., by the Tx, Link, or Rx) to an extent roughly proportional to their amplitude, thus introducing noise and/or distortion. Thus, digital signals RFin that have an amplitude greater than a maximum amplitude (that depends on system device characteristics), can emerge too noisy or distorted (i.e., a SNR and/or NPR that is less than 40). The range of signal amplitudes that includes amplitudes that are not too small, nor too large, and that will emerge from the system with an NPR equal to or higher than the predetermined minimum NPR, is referred to as the “dynamic range.”

FIG. 1B is a sketch depicting measured NPR (measured between RFin and RFout) graphed as a function of the amplitude of input signals (RFin), through the typical digital signal transmission system 100 of FIG. 1A. The dynamic range of the system 100 is characterized by the range of amplitudes (i.e., 10 dBmV to 40 dBmV) of input signals RFin that emerge from the system at NPRs equal to or greater than the predetermined minimum NPR (i.e., 40). As shown in FIG. 1A, it is typical in a system 100 of the related art that some signals having amplitudes within the dynamic range of the system 100, will be transmitted through the system 100 associated with NPR values that substantially exceed the predetermined minimum NPR.

A digital signal transmission system having maximally wide dynamic range, and particularly a system that does not introduce significant gain nor attenuation to power level of the outputted RF signal RFout relative to the input RFin, is desirable. However, conventional techniques for increasing the dynamic range of such a system 100 generally entail providing more-expensive system components (e.g., a higher fidelity transmitter Tx and/or receiver Rx) and/or higher quality (i.e, more expensive) optical LINK (130) media etc. The expense of such physical upgrades is often economically prohibitive. But, the limited dynamic range of an economical installed terrestrial system 100 can limit the usefulness, expandability, and performance of such a system.

There is thus a need for a method for transmitting RF signals through an optical link, and an economical RF digital signal transmission system, that provide an enhanced (i.e., wider) effective dynamic range.

### SUMMARY OF THE INVENTION

The present invention overcomes physical and economic limitations on the dynamic range of a RF digital signal transmission system that includes an optical link. The disclosed invention is applicable to the entire cable television (CATV) frequency range, and may be especially useful in lower frequency CATV applications such as transmission of end-user supplied information, such as programming and/or website section information, from the set-top box back to the commercial CATV provider. RF digital signals that may be transmitted through the inventive RF digital signal transmission system may include QAM (e.g., M-ary Quadrature Amplitude Modulated), Baseband, QPSK and other types.

The present invention exploits the knowledge that in a typical RF digital signal transmission system, such as system 100 shown in FIG. 1A, it is typical that some range of amplitudes (of RFin signals) within the dynamic range of the system 100, will be transmitted with NPR values that substantially exceed the predetermined minimum NPR. In other words, some amplitudes (of RFin signals) will produce output signals (RFout) that have more SNR and/or NPR than is needed for faithful transmission of encoded information. The present invention further exploits a discovery that such “excess performance” (i.e., higher than necessary NPR) of a typical system 100 can be purposefully sacrificed with the result of effectively enhancing (widening) the dynamic range of such a system (i.e., without improving the quality of the optical LINK (130) nor improving the fidelity of either the transmitter (Tx) or the Receiver (Rx)).

In a first general aspect, the present invention provides an apparatus for communicating radio frequency (RF) informational signals having a RF power level, through an optical link medium, said apparatus comprising: a first conductor adapted to carry said informational signals as electrical signals into the apparatus; a RF level sensor operatively coupled to the first conductor, adapted to measure the RF power level and to output a control signal according to said RF power level; a first RF attenuator adapted to be operatively controlled by the control signal, and adapted to attenuate the electrical signals from the first conductor prior to being communicated through said optical link medium; a transmitter adapted to transmit the electrical signals as optical signals into the optical link medium; a receiver adapted to receive the optical signals from the optical link medium, said receiver being operatively coupled to a second conductor adapted to carry said informational signals as electrical signals out of the apparatus.

In a second general aspect, the present invention provides an apparatus for enhancing the dynamic range of an optical transmission system, the optical transmission system including a RF transmitter for transmitting digital signals, an RF receiver for receiving the digital signals, and an optical link operatively connecting the RF transmitter to the RF receiver, the apparatus comprising: RF sensor adapted to measure the power level of RF digital signals to be transmitted by the RF transmitter, the RF sensor having a sensor output corresponding to said power level; and a first RF attenuator operatively coupled to the RF sensor and adapted to attenuate the RF digital signals prior to being transmitted by the RF transmitter, wherein the attenuation performed by the first RF attenuator corresponds to the sensor output.

In a third general aspect, the present invention provides an optical transmission system comprising: an optical signal transmitter section; an optical signal receiver section; an optical link medium being operatively connected between the optical signal transmitter section and the optical signal receiver section to form an included transmission system having a dynamic range; an RF stabilization system operationally connected to said transmitter section and to a first conductor carrying in an RF signal having a first RF power level; an RF stabilization system operationally connected to said receiver section and to a second conductor carrying out the RF signal at a second RF power level; wherein the RF stabilization systems operate to make the effective dynamic range of the apparatus substantially wider than the dynamic range of the included transmission system.

In a fourth general aspect, the present invention provides an apparatus for enhancing the dynamic range of an optical transmission system, the optical transmission system including an RF transmitter for transmitting digital signals, an RF receiver for receiving the digital signals, and an optical link operatively connecting the RF transmitter to the RF receiver, the apparatus comprising: an RF sensor adapted to measure the power level of RF digital signals to be transmitted by the RF transmitter, the RF sensor having a sensor output corresponding to said power level, wherein the sensor output is adapted to be transmitted to the RF receiver; RF attenuator operatively coupled to the RF sensor and adapted to attenuate the RF digital signals prior to being transmitted by the RF transmitter, wherein an attenuation performed by the RF attenuator is greater when the measured power level is higher than the dynamic range than when the measured power level is within the dynamic range; and a RF amplifier operatively coupled to the RF receiver and adapted to amplify the digital signals, wherein during operation of the apparatus the magnitude of the amplification performed by the RF amplifier is approximately the same as the magnitude of the attenuation performed by the RF attenuator.

In a fifth general aspect, the present invention provides a method for enhancing an effective dynamic range of an optical transmission system including a transmitter, an optical link, and a receiver, and for transmitting RF electronic signals as light signals through the optical link to the receiver that outputs the light signals as transmitted RF electronic signals, the method comprising: measuring a first RF power level of the RF electronic signals to be transmitted; transforming the RF electronic signals to a transformed RF power level before the RF electronic signals are transmitted as light signals by the transmitter, wherein the noise power ratio (NPR) of the transmitted RF electronic signals is greater than it would be if such transforming had not been performed; and outputting the transmitted RF electronic signals at within ±0.5 dB of the first RF power level.

In a sixth general aspect, the present invention provides a method for communicating radio frequency (RF) informational signals having a RF power level, through an optical link medium, said method comprising: providing a first conductor adapted to carry said informational signals as electrical signals into the apparatus; providing a RF level sensor operatively coupled to the first conductor, adapted to measure the RF power level and to output a control signal according to said RF power level; providing a first RF attenuator adapted to be operatively controlled by the control signal, and adapted to attenuate the electrical signals from the first conductor prior to being communicated through said optical link medium; providing a transmitter adapted to transmit the electrical signals as optical signals into the optical link medium; providing a receiver adapted to receive the optical signals from the optical link medium, said receiver being operatively coupled to a second conductor adapted to output said informational signals as electrical signals; and outputting said electrical signals at said second conductor at ±0.5 dB of the RF power level.

The foregoing and other features and advantages of the invention will be apparent from the following more particular description of embodiments of the invention.

### BRIEF DESCRIPTION OF THE DRAWINGS

The features and inventive aspects of the present invention will become more apparent upon reading the following detailed description, claims, and drawings, of which the following is a brief description.

FIG. 1A is a block diagram depicts a typical RF digital signal transmission system of the related art;

FIG. 1B is a sketch depicting measured NPR graphed as a function of the amplitude of input signals, through the digital signal transmission system of FIG. 1A;

FIG. 2 is a block diagram depicting a RF digital signal transmission system supporting an enhanced dynamic range, in accordance with embodiments of the present invention;

FIG. 3 is a sketch depicting enhanced NPR graphed as a function of the amplitude of input signals, through the digital signal transmission system of FIG. 2;

FIG. 4A is a block diagram depicting the internal components of a first embodiment of the first RF Level Transforming circuit 250 in system 200 as shown in FIG. 2;

FIG. 4B is a block diagram depicting the internal components of a first embodiment of the first RF Level Transforming circuit 250 in system 200 as shown in FIG. 2;

FIG. 5 is a sketch depicting enhanced NPR graphed as a function of the amplitude of input signals, through the digital signal transmission system of FIG. 2;

FIG. 6 is a block diagram depicting the internal components of a first embodiment of the optional second RF Level Transforming circuit 260 in system 200 as shown in FIG. 2.

It should be noted that the same element numbers are assigned to components having the same, or approximately the same functions and structural features. Thus, elements in different figures and labeled with the same element number may be identical, or substantially similar in composition, structure and/or function, and where the function of such element has already been explained, there is no necessity for repeated explanation thereof in the detailed description.

### DETAILED DESCRIPTION OF THE INVENTION

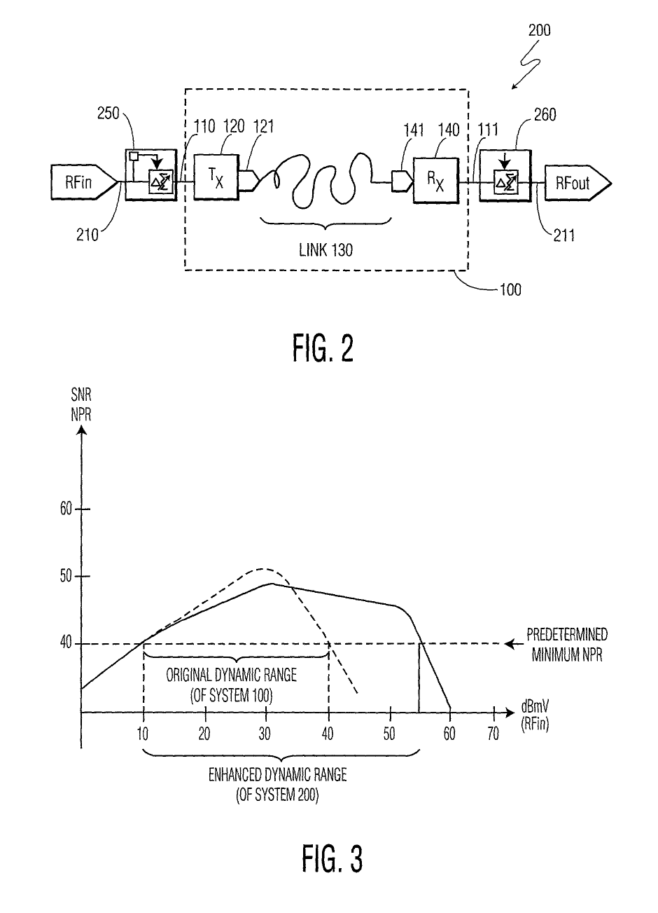

FIG. 2 is a block diagram depicting a RF digital signal transmission system for transmission of informational signals (i.e. informational signals carried into the system 200 as RF electronic signals RFin, and out of the system as RF electronic signals RFout) through an optical link 130, and supporting an enhanced dynamic range, in accordance with embodiments of the present invention. The system 200 includes an external conductor 210 for carrying in radio frequency (RF) digital information signals as electronic signals RFin. The system 200 also includes an external conductor 211 for carrying out the radio frequency (RF) digital informational signals as electronic signals RFout. Embodiments of the system 200 may further include an intact RF transmitter-LINK-receiver system 100 of the related art. Alternatively, the active components (e.g., 120, and 140) of the related art system 100 may be modified so as to be physically and electrically integrated with additional components (e.g., 250 and 260 respectively) that are unique to the inventive system 200.

As shown in FIG. 2, the system further comprises a first RF Level Transforming circuit 250, adapted to sense (i.e., measure, integrate, or compute) the average power level (i.e., amplitude) of the electronic signals (RFin) entering the system during a predetermined (or during a dynamically variable) period of time (e.g., ranging from one second to several minutes), and to accordingly transform (i.e, amplify or attenuate) the level of such inputted electronic signals (before they are transmitted by the transmitter 120 through the link 130), in such a manner as to enhance the effective dynamic range of the included system 200 so that it is wider than the physical dynamic range of the included transmitter-link-receiver system 100.

The active components (e.g., 250 and 260) unique to the system 200, (which will be more particularly described below) are adapted to perform a method for enhancing the effective dynamic range of a system 100 including a transmitter 120, an optical link 130, and a receiver 140. The method performed by the system 200 comprises: measuring during a period of time the original signal power level (i.e., amplitude) of RF electronic signals (RFin), wherein the RF electronic signals are to be transmitted as light signals by a transmitter 120 through an optical link 130 to a receiver that outputs the light signals as RF electronic signals; transforming (e.g., attenuating) the amplitude of such RF electronic signals to a transformed (e.g, attenuated amplitude) level before the RF electronic signals are transmitted as light signals by the transmitter 120, whereby the noise power ratio (PR) of the transmitted RF electronic signals is greater than it would be if such attenuation had not been performed. The will generally also include a second transformation of the signals after the passing through the receiver 140, such that the RF signals RFout output from the system 200 shall have approximately the original signal power level (i.e., amplitude). Thus, the second transformation at the output end (e.g., at 260) of the system 200 will perform the inverse transformation (mirror) as was performed at the input end (e.g., at 250).

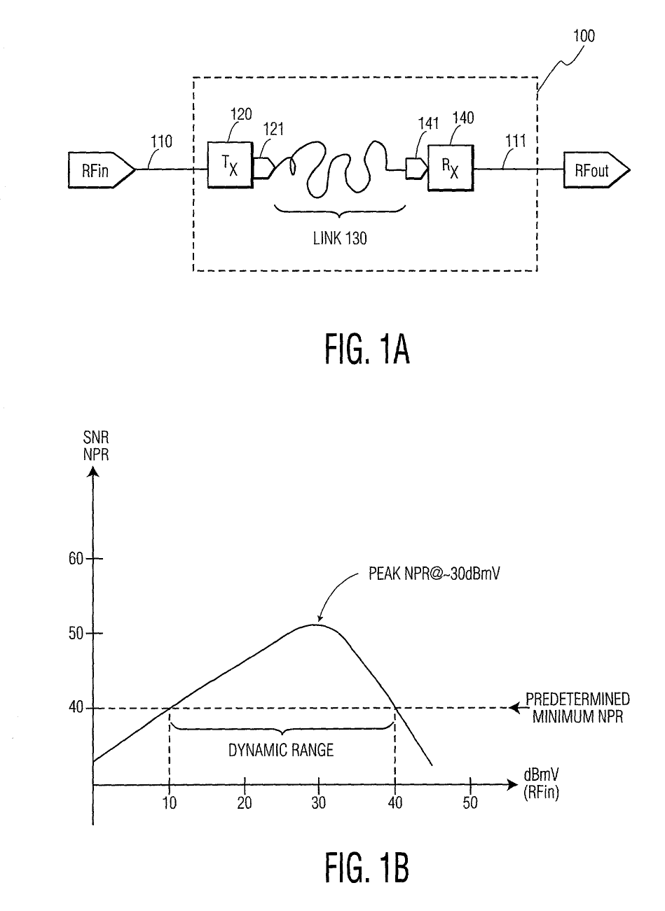

As an example, in the case of the exemplary NPR function (shown in FIG. 1B) for the transmitter-link-receiver system 100 included within system 200, it may be observed that a signal having amplitude 50 dBmV will pass through the system 100 with an associated NPR of less than 40 (i.e., inadequate), while a signal having the smaller amplitude 30 dBmV will pass through the system 100 with an associated NPR of approximately 50. Thus, if the 50 dBmV signal were transformed (e.g., attenuated) down to 30 dBmV before passing through the system 100, the emerging attenuated signal would theoretically be associated with an NPR of nearly 50 (e.g., the peak NPR value, at 30 bBmV).

FIG. 3 is a sketch depicting exemplary NPR graphed as a function of the power level (i.e., amplitude) of input signals (RFin), through the digital signal transmission system 200 of FIG. 2. FIG. 3 further depicts how the ENHANCED DYNAMIC RANGE of system 200 may be compared with the “original dynamic range” of the included system 100 (which was first depicted in FIG. 1B). In practice, the process of attenuating the 50 dBmV of signals might to some extent introduce distortion and/or noise into the RF electronic signal, resulting in some reduction of the final NPR for the outputted signals. However, the 10 NPR-unit margin of “excess performance” (i.e., 50−40=10) (i.e., computed at the attenuated-to amplitude of 30 bBmV by subtracting the actual NMR value 50 from the predetermined minimum value 40) can be exploited to output RF signals from the system 200 with an NPR of at least 40 (e.g., about 45 as shown in the sketch of FIG. 3). Thus, by sacrificing the “excess” NPR, RF signals of amplitudes that would ordinarily not pass through the system 100 with sufficient NPR (i.e., signals of amplitudes beyond the physical dynamic range of the system 100) can be transformed (e.g., attenuated) and then passed though the system 100 with the requisite NPR (i.e., equal to or greater than 40).

A pre-transmission attenuation scheme could be advantageously practiced (within limits imposed by the fidelity of real attenuating circuits) with signals of any amplitude greater than the top of the dynamic range (e.g., greater than 40 dBmV) of the system 100. Accordingly, NPR values equal to or greater than 40 could be accorded to signals of amplitudes beyond (i.e., greater than) the dynamic range (e.g., greater than 40 dBmV) of the system 100, thus effectively extending the upper limits of the effective dynamic range of the system 200 beyond the original dynamic range of system 100 (as illustrated in FIG. 3).

Attenuation of electronic RF signals (RFin) of amplitudes beyond the dynamic range of the included system 100 could be carried out by many schemes and many circuits known to persons skilled in the art. For example the first RF Level Transforming circuit 250 might be designed such that all signals having amplitudes greater than a certain predetermined number of dBmV (e.g., greater than 35 dBmV) shall be selectively attenuated. Selective attenuation can be facilitated by some type of RF power level sensor, within the system 200 (e.g., within the first RF Level Transforming circuit 250) to detect the average RF power level of the RF signals passing through the system at that point in time and to generate a control signal to continuously control or intermittently trigger the attenuation.

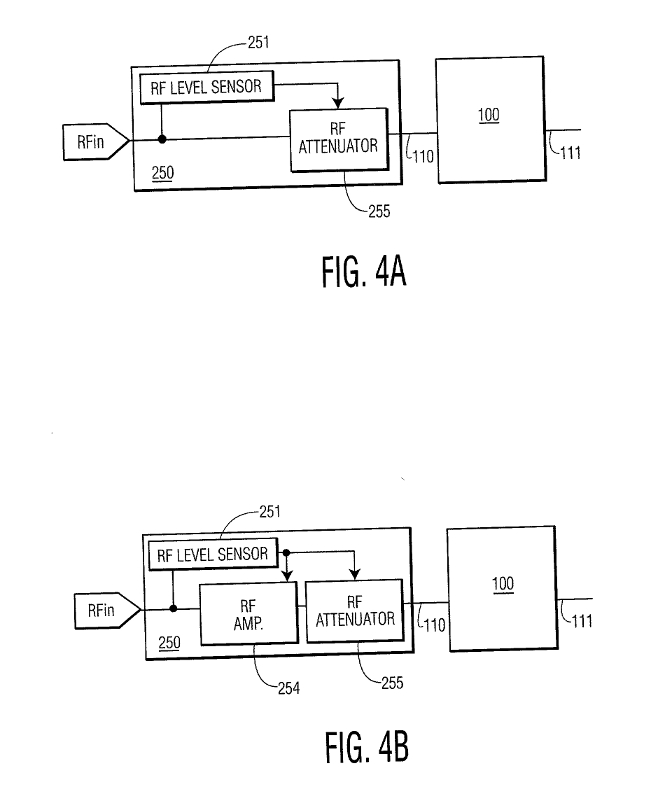

FIG. 4A is a block diagram depicting the internal components of a first embodiment of the first RF Level Transforming circuit of system 200 as shown in FIG. 2. The first RF Level Transforming circuit 250 includes at least an RF attenuator 255 adapted to attenuate RF power levels (amplitudes) of electronic signals (RFin) passed to the system 100. The first RF Level Transforming circuit 250 may further include RF level sensor 251. RF level sensor 251 could be an explicit component of the system 200 extrinsic to the RF attenuator 255 (as shown in FIG. 4A) or the RF power level sensing function could be performed as an implicit function of embodiments of an RF attenuator 255 itself.

A discrete RF level sensor 251 could be operated as a digital switch enabling the RF attenuator 255 when the RF power level (i.e., amplitude) of RFin exceeds (and/or falls below) a predetermined threshold amount. Accordingly, a selective attenuation scheme might be implemented as a uniform attenuation scheme, such as where a constant (e.g., 10 dBmV) attenuation is applied to all signals of amplitudes greater than the predetermined of dBmV. The effect of such a selective but uniform attenuation scheme would likely extend the dynamic range upward by an amount approximately equal to the magnitude of the uniform attenuation. Such a “uniform attenuation scheme” need not be perfectly uniform over a range of RF power levels of RFin, nor even predictable (i.e., the amount of transformation of amplitude of signals RFin coming into the system 200 at a particular RF power level need not be predictable nor deterministic at any point in time), as long as the transformation (i.e., amplification/attenuation) scheme can be mirrored and/or the transformation counteracted in real time by equipment provided at the receiver end of the system 200.

The attenuation of the RF power level may also be linear and/or deterministic, e.g., proportional to the RF power level at conductor 210. The RF sensor could produce a control signal that is proportional or approximately proportional to the RF power level. The RF attenuator 255 may be or operate like potentiometer controlled by the control signal, so as to increase the attenuation approximately in proportion to an increase in RF power level. The RF attenuator 255 may be implemented with a PIN diode (e.g., a PIN diode forward biased by a current controlled by the RF sensor). Alternatively, various linear and nonlinear attenuation schemes could be implemented within the circuit 250, whereby the dynamic range of the system 200 could be extended above the upper limits of the dynamic range of system 100. Accordingly, the RF level sensor 251 could be operated as an analogue sensor that continuously controls the magnitude of the attenuation performed by RF attenuator 255 so as to (proportionally, linearly, or otherwise deterministicly, or non-deterministicly) increase the attenuation (i.e., reduce the amplitude of the high RF level signal passing to system 100) as the RF power level of RFin increases towards or above the top of the dynamic range of system 100.

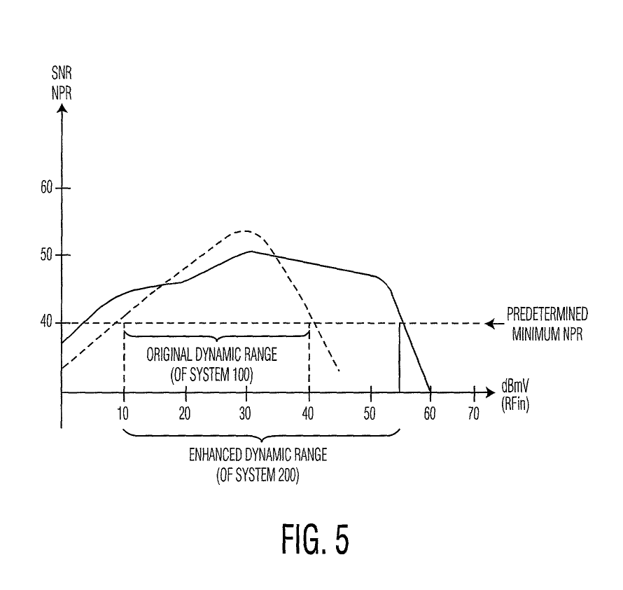

FIG. 4B is a block diagram depicting the internal components of a second embodiment of the first RF Level Transforming circuit 250 in system 200 as shown in FIG. 2. In alternative embodiments of the invention, the first RF Level Transforming circuit 250 may further include an RF amplifier 254 adapted to amplify RF power levels (amplitudes) of electronic signals (RFin) passed to the system 100. The RF amplifier 254 could be used to amplify the RFin signal at times when the RF power level (i.e., amplitude) of signals RFin is below the lower bounds of the dynamic range of the system 100, so as to extend the dynamic range of the system 200 lower than the lower bound of the dynamic range of system 100 (as shown in FIG. 5). The RF level sensor 251 could be adapted to control the operation of the RF amplifier 254, in an inverse manner as it is used to control the operation of the RF attenuator 255. In typical embodiments, only one of the RF amplifier 254 and RF attenuator 255 will be substantially active at any given point in time (i.e. typically, the RF attenuator 255 will not significantly affect the amplitude of the signals while the RF amplifier 254 is active, and vice versa, and various schemes for avoiding contention between the RF attenuator 255 and the RF amplifier 254 are know to persons skilled in the art. In some embodiments of the invention, a single circuit component may perform the functions of both the RF attenuator 255 and the RF amplifier 254, alternating between such functions depending upon the output of the RF level sensor 251). Providing an RF amplifier within the first RF Level Transforming circuit 250 facilitates the downward enhancement of the dynamic range of system 200 to below the lower limit of the dynamic range of system 100.

FIG. 5 is a sketch depicting enhanced dynamic range of embodiments of system 200 that include Amplifier 254 graphed as a function of the amplitude of RF input signals, through the digital signal transmission system of FIG. 2. The enhanced dynamic range of the system 200 is extended below the dynamic range of system 100 by amplifying RF signals (RFin) having amplitudes below the dynamic range of system 100.

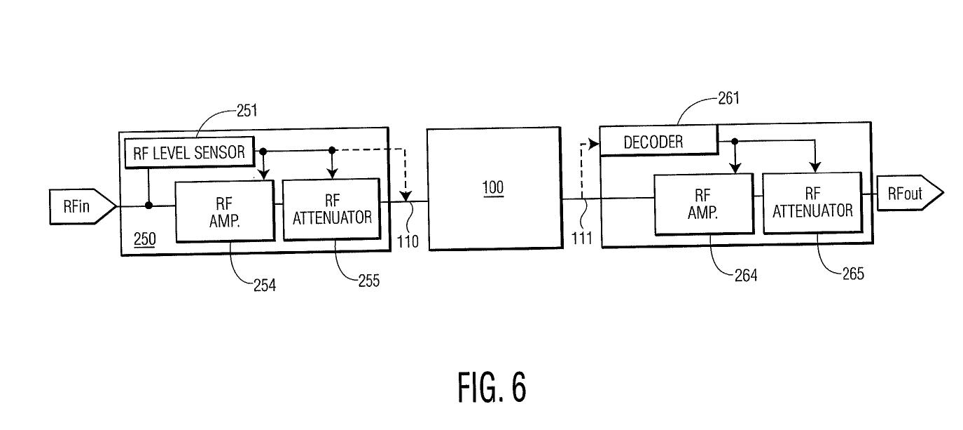

FIG. 6 is a block diagram depicting the internal components of the optional second RF Level Transforming circuit 260 in system 200 as shown in FIG. 2. In some embodiments of the invention, the system 200 may comprise an (optional) second RF Level Transforming circuit 260 adapted to reverse the transformation (i.e., to provide amplification to exactly counteract a signal attenuation performed by the first RF Level Transforming circuit 250; or to provide attenuation to counteract an amplification performed by the first RF Level Transforming circuit 250). The second RF Level Transforming circuit 260 can mirror the first RF Level Transforming circuit 250 and adjust its Amplification/Attenuation so as to maintain (at RFout) the same RF power level (i.e., amplitude) as was input to the system 200 (at RFin). The result of this is to enhance the dynamic range of the system 200 while also providing RFout at the original RF power level (i.e., amplitude) as was originally received at RFin. The second RF Level Transforming circuit 260 may be particularly useful in CATV systems wherein Automatic Gain Controllers (AGCs) are present, to avoid contention of the system 200 with such AGCs.

In embodiments of the invention where the second RF Level Transforming circuit 260 is supplied for maintaining the RF power level at RFout, it is desirable that a continuous communication exists between the first RF Level Transforming circuit 250 and the second RF Level Transforming circuit 260. The RF level sensor 251 may be adapted to output a signal that indicates the power level of RFin and which can be converted to an RF signal encoding that power level information which can be injected into the system 100 and then transmitted through the optical link (130, see FIG. 2) to a RF decoder 261 in (or operatively coupled to) the second RF Level Transforming circuit 260. The RF decoder 261 will decode the RF signal encoding that power level information, and supply that information to control the RF Amplifier 264 and/or RF Attenuator 265 within the second RF Level Transforming circuit 260, so as to maintain the power level (i.e., amplitude) of RFout the same as the power level of RFin. The RFout signals will generally be faithful reproductions of the original digital signals (RFin) without significant changes in amplitude (i.e. no great net gain nor attenuation) except for any noise and/or distortion introduced during passage through the system 200. Generally, the amplitude (i.e., RF power level) of the RF digital signals (RFout) emerging from the system 200 will be approximately the same as the RF power level of the same digital signals (RFin) when they entered the system 200. Typically, the RF power level (i.e., amplitude) of the emergent RFout signals will be within plus or minus one-half decibels (±0.5 dB) of the RF power level of RFin. Embodiments of the system 200 may be also be designed so that the RF power level (i.e., amplitude) of the emergent RFout signals will be within plus or minus one-quarter decibels (±0.25 dB) of the RF power level of RFin, etc.

Alternative embodiments of the invention may be implemented by adapting the circuits disclosed in commonly assigned co-pending US patent application No. ______, filed ______ 2001, (titled, RF LEVEL STABILIZATION OF OPTICAL LINK OVER TEMPERATURE) and incorporated herein by reference. For example, the “RF sensor” in FIGS. 4 and 5 of the co-pending application may be adapted to perform the functions of sensor 251 of FIG. 2 herein, and be operatively connected to the RF Amplifier and RF Attenuator circuits depicted in FIG. 4 and FIG. 5 of the co-pending application, to enable those circuits to perform the methods of the present invention (i.e., to enhance the dynamic range of the transmitter-optical link-receiver system 400 and 500) included in FIGS. 4 and 5 of the co-pending application. The RF power level measured by an RF power level sensor may be encoded (e.g., by modulator 520 of FIG. 5) and transmitted through the optical link to control the RF Amplifier and RF Attenuator at the RF output end of the system. The RF Level Stabilization circuits of the co-pending are well adapted to implement the method of the present invention, wherein the RF power level (i.e., amplitude) supplied to the transmitter (e.g., “laser” 142) is maintained at a constant RF level. Optimally, the constant RF level would be at or near the “peak” of the NPR curve of the transmitter-optical link-receiver system. The selection of the RF level at or near the “peak”of the NPR curve would tend to maximize the dynamic range of the constant-level RF digital signal transmission system disclosed in FIG. 4 and FIG. 5 of the co-pending application.

Embodiments of the present invention have been disclosed. A person of ordinary skill in the art would realize, however, that certain modifications would come within the teachings of this invention. Therefore, the following claims should be studied to determine the true scope and content of the invention.

We claim:

1. An apparatus for communicating radio frequency (RF) informational signals having a RF power level, through an optical link medium, said apparatus comprising:
a first conductor adapted to carry said informational signals as electrical signals into the apparatus;
a RF level sensor operatively coupled to the first conductor, adapted to measure the RF power level and to output a control signal according to said RF power level;
a first RF attenuator adapted to be operatively controlled by the control signal, and adapted to attenuate the electrical signals from the first conductor prior to being communicated through said optical link medium;
a transmitter adapted to transmit the electrical signals as optical signals into the optical link medium;
a receiver adapted to receive the optical signals from the optical link medium, said receiver being operatively coupled to a second conductor adapted to carry said informational signals as electrical signals out of the apparatus.

2. The apparatus of claim 1 further comprising a first RF amplifier adapted to be operatively controlled by the control signal, and adapted to amplify the electrical signals from the first conductor prior to being communicated through said optical link medium.

3. The apparatus of claim 2 wherein the control signal is communicated though said optical link medium, and further comprising a second RF attenuator operatively coupled to the receiver and adapted to be operatively controlled by the encoded control signal, and adapted to attenuate the electrical signals on said second conductor.

4. The apparatus of claim 3 wherein the second RF attenuator is adapted to attenuate the electrical signals on said second conductor to within ±0.5 dB of the RF power level.

5. The apparatus of claim 3 wherein the second RF attenuator is adapted to attenuate the electrical signals on said second conductor to approximately the RF power level.

6. The apparatus of claim 2 wherein the control signal is communicated though said optical link medium, and further comprising a second RF attenuator operatively coupled to the receiver and adapted to be operatively controlled by the encoded control signal, and adapted to attenuate the electrical signals on said second conductor, and further comprising a second RF amplifier operatively coupled to the receiver and adapted to be operatively controlled by the control signal, and adapted to amplify the electrical signals on said second conductor.

7. The apparatus of claim 1 wherein the control signal is communicated though said optical link medium, and further comprising a second RF amplifier operatively coupled to the receiver and adapted to be operatively controlled by the control signal, and adapted to amplify the electrical signals on said second conductor.

8. The apparatus of claim 7 wherein second RF amplifier is adapted to amplify the electrical signals on said second conductor to within ±0.5 dB of the RF power level.

9. The apparatus of claim 7 wherein second RF amplifier is adapted to amplify the electrical signals on said second conductor to approximately the RF power level.

10. An apparatus for enhancing the dynamic range of an optical transmission system, the optical transmission system including a RF transmitter for transmitting digital signals, an RF receiver for receiving the digital signals, and an optical link operatively connecting the RF transmitter to the RF receiver, the apparatus comprising:
an RF sensor adapted to measure the power level of RF digital signals to be transmitted by the RF transmitter, the RF sensor having a sensor output corresponding to said power level;
a first RF attenuator operatively coupled to the RF sensor and adapted to attenuate the RF digital signals prior to being transmitted by the RF transmitter, wherein the attenuation performed by the first RF attenuator corresponds to the sensor output.

11. The apparatus of claim 10, wherein the sensor output is adapted to be transmitted to the RF receiver.

12. The apparatus of claim 11, further comprising a second RF amplifier operatively coupled to the RF receiver, and adapted to amplify the digital signals, wherein the amplification performed by the second RF amplifier corresponds to the sensor output.

13. The apparatus of claim 12, further comprising a second RF amplifier operatively coupled to the RF receiver, wherein during operation of the apparatus the magnitude of the amplification performed by the second RF amplifier is approximately the same as the magnitude of the attenuation performed by the first RF attenuator.

14. The apparatus of claim 10, further comprising a first RF amplifier operatively coupled to the RF sensor and adapted to amplify the RF digital electrical signals prior to being transmitted by the RF transmitter, wherein the amplification performed by the first RF varies inversely with the sensor output.

15. The apparatus of claim 14, wherein the sensor output is transmitted to the RF receiver, and further comprising a second RF attenuator operatively coupled to the RF receiver, and adapted to attenuate the received digital signals, wherein the attenuation performed by the second RF attenuator varies inversely with the sensor output.

16. The apparatus of claim 14, further comprising a second RF attenuator operatively coupled to the RF receiver, wherein during operation of the apparatus the magnitude of the attenuation performed by the second RF attenuator is approximately the same as the magnitude of the amplification performed by the first RF attenuator.

17. An optical transmission system comprising:
an optical signal transmitter section;
an optical signal receiver section;
an optical link medium being operatively connected between the optical signal transmitter section and the optical signal receiver section to form an included transmission system having a dynamic range;
an RF stabilization system operationally connected to said transmitter section and to a first conductor carrying in an RF signal having a first RF power level;
an RF stabilization system operationally connected to said receiver section and to a second conductor carrying out the RF signal at a second RF power level;
wherein the RF stabilization systems operate to make the effective dynamic range of the apparatus substantially wider than the dynamic range of the included transmission system.

18. The optical transmission system of claim 17, wherein the RF stabilization systems maintain the second RF power level within ±0.5 dB of the first RF power level.

19. The optical transmission of claim 10, wherein the optical transmission system is a cable television (CATV) system.

20. An apparatus for enhancing the dynamic range of an optical transmission system, the optical transmission system including an RF transmitter for transmitting digital signals, an RF receiver for receiving the digital signals, and an optical link operatively connecting the RF transmitter to the RF receiver, the apparatus comprising:
an RF sensor adapted to measure the power level of RF digital signals to be transmitted by the RF transmitter, the RF sensor having a sensor output corresponding to said power level, wherein the sensor output is adapted to be transmitted to the RF receiver;
a RF attenuator operatively coupled to the RF sensor and adapted to attenuate the RF digital signals prior to being transmitted by the RF transmitter, wherein an attenuation performed by the RF attenuator is greater when the measured power level is higher than the dynamic range than when the measured power level is within the dynamic range;
and a RF amplifier operatively coupled to the RF receiver and adapted to amplify the digital signals, wherein during operation of the apparatus the magnitude of the amplification performed by the RF amplifier is approximately the same as the magnitude of the attenuation performed by the RF attenuator.

21. A method for enhancing an effective dynamic range of an optical transmission system including a transmitter, an optical link, and a receiver, and for transmitting RF electronic signals as light signals through the optical link to the receiver that outputs the light signals as transmitted RF electronic signals, the method comprising:
measuring a first RF power level of the RF electronic signals to be transmitted;
transforming the RF electronic signals to a transformed RF power level before the RF electronic signals are transmitted as light signals by the transmitter; and
outputting the transmitted RF electronic signals at within ±0.5 dB of the first RF power level.

22. The method of claim 21, wherein the noise power ratio (NPR) of the transmitted RF electronic signals is greater than it would be if such transforming had not been performed

23. The method of claim 22, wherein said transforming is attenuating, and said transformed RF power level is less than the first RF power level.

24. The method of claim 22, wherein said transforming is amplifying, and said transformed RF power level is greater than the first RF power level.

25. The apparatus of claim 22, wherein the RF electronic signals are cable television (CATV) signals.

26. A method for communicating radio frequency (RF) informational signals having a RF power level, through an optical link medium, said method comprising:
providing a first conductor adapted to carry said informational signals as electrical signals into the apparatus;
providing a RF level sensor operatively coupled to the first conductor, adapted to measure the RF power level and to output a control signal according to said RF power level;
providing a first RF attenuator adapted to be operatively controlled by the control signal, and adapted to attenuate the electrical signals from the first conductor prior to being communicated through said optical link medium;
providing a transmitter adapted to transmit the electrical signals as optical signals into the optical link medium;
providing a receiver adapted to receive the optical signals from the optical link medium, said receiver being operatively coupled to a second conductor adapted to output said informational signals as electrical signals; and
outputting said electrical signals at said second conductor at ±0.5 dB of the RF power level.
